(19) United States
(12) Patent Application Publication
(10) Pub. No.: US 2004/0046908 A1
(43) Pub. Date: Mar. 11, 2004

(54) Liquid crystal display device with multiple dielectric layers

(75) Inventors: Chu-Jung Shih, Miao-Li (TW); Jr-Hong Chen, Miao-Li (TW); I-Min Lu, Miao-Li (TW)

Correspondence Address: Finnegan, Henderson, Farabow,, Garrett & Dunner, L.L.P., 1300 I Street, N.W., Washington, DC, 20005-3315, US

(73) Assignee: Toppoly Optoelectronics Corp.

(21) Appl. No.: 10/237,669

(22) Filed: Sep. 10, 2002

(51) Int. Cl. G02F 1/1335

(52) U.S. Cl. 349/113

(57) ABSTRACT

A liquid crystal display device that includes a pixel electrode, a liquid crystal layer, a first dielectric layer formed between the pixel electrode and the liquid crystal layer having a first index of refraction and a first optical thickness, and a second dielectric layer formed between the first dielectric layer and the liquid crystal layer having a second index of refraction and a second optical thickness, wherein the second index of refraction is larger than the first index of refraction and the second optical thickness is larger than the first optical thickness.

### DESCRIPTION

1. Technical Field

This invention pertains in general to a liquid crystal display device and, more particularly, to a liquid crystal display device with multiple dielectric layers for enhancing reflectivity.

2. Background

A reflective or reflective-transmissive liquid crystal display (LCD) device generally uses aluminum (Al), aluminum-neodymium (Al—Nd) or silver (Ag) for pixel electrodes, which are disposed between a liquid crystal layer and an active matrix layer in an LCD device. Each pixel electrode is connected to a contact electrode of a thin film transistor (TFT) in the matrix layer and driven by the TFT. It has been found that if the metal pixel electrodes are disposed in direct contact with the liquid crystal layer, the portions of the metal pixel electrodes that interface with the liquid crystal layer are susceptible to corrosion. Therefore, conventionally, a dielectric coating is formed over the metal pixel electrodes. The dielectric coating also serves as an optical reflection surface for a natural light radiated from a glass substrate of the LCD device. An example of the conventional designs is illustrated in FIG. 1.

FIG. 1 is a reproduction of FIG. 1 of U.S. Pat. No. 5,926,240 (hereinafter the '240 patent) to Hirota et al., entitled “Liquid Crystal Display Apparatus Comprise a Silicon Nitride Dielectric Film with Thickness in a Range of 80 mm-170 mm and Disposes between a Reflective Pixel Elect and LC Layer.” Referring to FIG. 1, a single-layer dielectric film 8, such as silicon nitride, is coated over reflective pixel electrodes 7 to isolate pixel electrodes 7 from a liquid crystal layer 9. According to the '240 patent, with the single dielectric film 8, reduction in the reflectivity of the reflective pixel electrodes 7 and degradation of the liquid crystal layer 9, which result from corrosion of the reflective pixel electrodes 7, will not occur. The single-layer dielectric film 8, however, is provided to prevent reduction in capacitance caused by a photo-activated current and reduction in reflectivity caused by corrosion of reflective pixel electrodes, and may not enhance the reflectivity of an LCD device. It is desired to provide an improved LCD device with enhanced reflectivity of pixel electrodes and decreases power consumption.

### SUMMARY OF THE INVENTION

Accordingly, the present invention is directed to LCD devices and methods that obviate one or more of the problems due to limitations and disadvantages of the related art.

Additional features and advantages of the present invention will be set forth in the description which follows, and in part will be apparent from the description, or may be learned by practice of the invention. The objectives and other advantages of the invention will be realized and attained by the devices and methods particularly pointed out in the written description and claims thereof, as well as the appended drawings.

To achieve these and other advantages, and in accordance with the purpose of the invention as embodied and broadly described, there is provided a liquid crystal display device that includes a pixel electrode, a liquid crystal layer, a first dielectric layer formed between the pixel electrode and the liquid crystal layer having a first index of refraction and a first optical thickness, and a second dielectric layer formed between the first dielectric layer and the liquid crystal layer having a second index of refraction and a second optical thickness, wherein the second index of refraction is larger than the first index of refraction and the second optical thickness is larger than the first optical thickness.

In one aspect, at least one additional dielectric layer is formed between the second dielectric layer and the liquid crystal layer, wherein the at least one additional dielectric layer includes a third dielectric layer having a third index of refraction and the second optical thickness.

In another aspect, the at least one additional dielectric layer includes a fourth dielectric layer formed between the third dielectric layer and the liquid crystal layer, wherein the fourth dielectric layer has a fourth index of refraction larger than the third index of refraction and the second optical thickness.

Also in accordance with the present invention, there is provided a method of making a liquid crystal display device having a pixel electrode and a liquid crystal layer. The method includes forming a first dielectric layer between the pixel electrode and the liquid crystal layer, the first dielectric layer having a first index of refraction and a first optical thickness, and forming a second dielectric layer between the first dielectric layer and the liquid crystal layer, the second dielectric layer having a second index of refraction and a second optical thickness, wherein the second index of refraction is larger than the first index of refraction and the second optical thickness is larger than the first optical thickness.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate embodiments consistent with the invention and, together with the description, serve to explain the objects, advantages, and principles of the invention.

In the drawings,

FIG. 1 is a cross-sectional view of a conventional LCD device;

FIG. 2 is a cross-sectional view of an LCD device in accordance with one embodiment consistent with the present invention; and

FIG. 3 is a cross-sectional view of an LCD device in accordance with another embodiment consistent with the present invention.

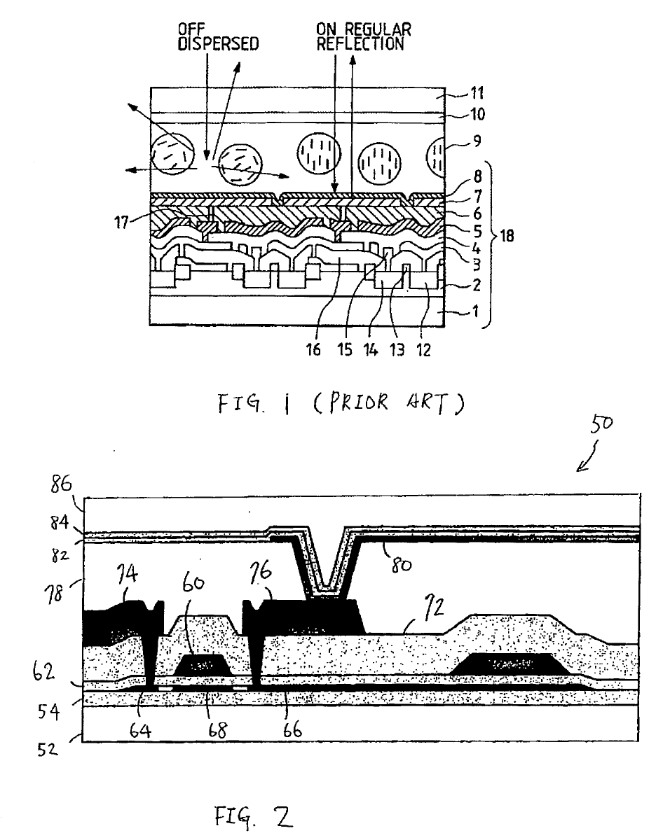

### DESCRIPTION OF THE EMBODIMENTS

Reference will now be made in detail to embodiments consistent with the invention, examples of which are illustrated in the accompanying drawings. Wherever possible, the same reference numbers will be used throughout the drawings to refer to the same or like parts.

FIG. 2 shows a cross-sectional view of an LCD device 50 consistent with the present invention. Referring to FIG. 2, LCD device 50 includes an insulation substrate 52 such as a glass substrate, an insulating layer 54 formed over substrate 52, an active device (not numbered) including a gate 60, a gate insulation layer 62, a first diffusion region 64, a second diffusion region 66, a channel region 68, a first contact 74 coupled to first diffusion region 64 and a second contact 76 coupled to second diffusion region 66, a passivation layer 72, a planarization layer 78, a pixel electrode 80 to serve as a reflective electrode, at least a pair of dielectric layers 82 and 84, and a liquid crystal layer 86. The pair of dielectric layers 82 and 84, instead of a single dielectric film in the above-mentioned conventional design, is provided to enhance the reflectivity of the pixel electrode 80, and observes the principle of admittance loci. Details of the principle of admittance loci are set forth, for example, in “Thin-Film Optical Filters” by H. A. Macleod, 2^{nd} edition, published by Macmillian Publishing Company.

The characteristic optical admittance, y, of a material is expressed as follows.

y=n−ik Equation 1:

where n is the index of refraction of the material, k is the coefficient of extinction, and i is the imaginary number. For metals, the value of k is often larger than the value of n. For example, the characteristic optical admittance of aluminum (Al) is 0.82−i5.99. For dielectric materials, the value of k is much smaller than the value of n. For example, the characteristic optical admittance of glass is 1.52−iE-7. Therefore, the values of y and n of a dielectric material are approximately the same. As is well known, for example, according to the Admittance Tracking Method, the reflectivity of a metal such as aluminum may be enhanced by coating dielectric materials over the metal. The thickness of a representative first dielectric layer formed over a metal for enhanced reflectivity is expressed as follows.

δ=(2π/λ)nd cos θ Equation 2:

where δ (delta) is an optical film thickness of the first dielectric layer, λ (lambda) is a center wavelength of a light reflected by the first dielectric layer, n is the index of refraction of the first dielectric material, d is a physical film thickness of the first dielectric material, and θ (theta) is an angle of incidence. For even greater enhanced reflectivity, a second dielectric layer may be formed having a thickness expressed as follows.

nd=λ/4 Equation 3:

where n is the index of refraction of the second dielectric material, d is the physical film thickness of the second dielectric layer, and λ is a center wavelength of a light reflected by the second dielectric layer.

Referring to FIG. 2, first dielectric layer 82 is formed between pixel electrode 80 and liquid crystal layer 86, and second dielectric layer 84 is formed between first dielectric layer 82 and liquid crystal layer 86, on first dielectric layer 82. Materials for dielectric layers 82 and 84 are chosen so that second dielectric layer 84 has a larger index of refraction than first dielectric layer 82. Examples of a low refractive index material are silicon oxide (SiO₂), barium fluoride (BaF₂), sodium fluoride (NaF), magnesium fluoride (MgF₂), aluminum fluoride (AlF₃), calcium fluoride (CaF₂), strontium fluoride (SrF₂) and so on. Examples of a high refractive index material are silicon nitride (Si₃N₄), titanium oxide (TiO₂), tantalum oxide (TaO₂ or Ta₂O₅), cerium oxide (CeO₂), aluminum oxide (Al₂O₃), magnesium oxide (MgO), hafnium oxide (HfO₂), zirconium oxide (ZrO₂), antimony oxide (Sb₂O₃), cerium fluoride (CeF₃), and so on.

In addition, second dielectric layer 84 has a larger optical film thickness than first dielectric layer 82. In determining the thickness, it may be assumed that λ is approximately 6000 Å and θ is approximately 0° because a reflective or reflective-transmissive LCD often uses natural light as a light source. Besides, the physical film thickness is assumed to be a low value to facilitate calculating the optical film thickness by an iteration method. In one embodiment, first dielectric layer 82 has an optical film thickness of 500 Å, and second dielectric layer 84 has an optical film thickness of 750 Å.

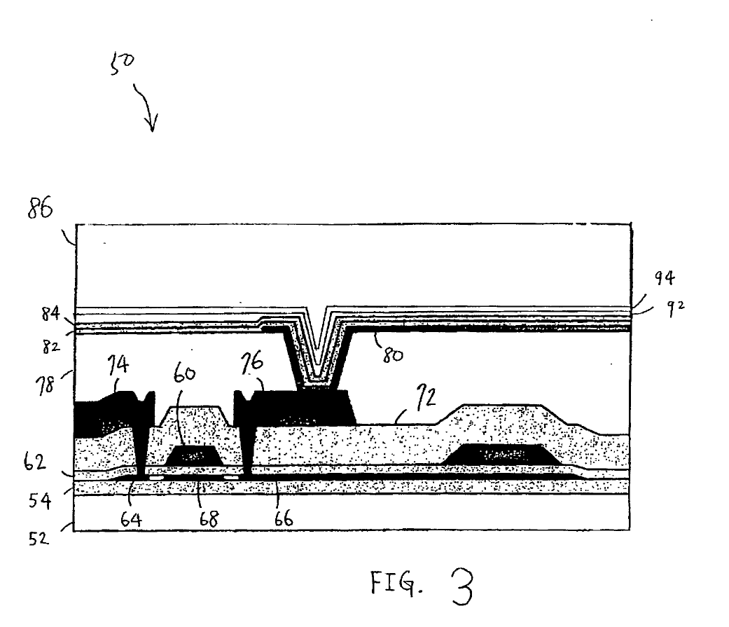

FIG. 3 shows another embodiment consistent with the present invention. Referring to FIG. 3, at least one dielectric layer, for example, a third dielectric layer 92, is formed between second dielectric layer 84 and liquid crystal layer 86, on second dielectric layer 84. Third dielectric layer 92 has a third index of refraction and the same optical thickness as second dielectric layer 84. In still another embodiment consistent with the present invention, a fourth dielectric layer 94 is formed between third dielectric layer 92 and liquid crystal layer 86, on third dielectric layer 92. Fourth dielectric layer 94 has a fourth index of refraction larger than the third index of refraction and the same optical thickness as third dielectric layer 92. In theory, the more the dielectric layers, the better the reflectivity. In one embodiment, a dielectric stack (not shown) may have as many as thirty layers of third and fourth dielectric layers 92 and 94 alternately laminated. Examples of the low and high index of refraction materials for the third and fourth dielectric layers, respectively, have been described above.

A method for providing an LCD device having enhanced reflectivity includes providing a pixel electrode 80, providing a liquid crystal layer 86, forming a first dielectric layer 82 between pixel electrode 80 and liquid crystal layer 86, and forming a second dielectric layer 84 between first dielectric layer 82 and liquid crystal layer 86, wherein first dielectric layer 82 has a first index of refraction and a first optical thickness, and second dielectric layer 84 has a second index of refraction and a second optical thickness, and wherein the second index of refraction is larger than the first index of refraction and the second optical thickness is larger than the first optical thickness.

It will be apparent to those skilled in the art that various modifications and variations can be made in the disclosed process without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A liquid crystal display device comprising:
a pixel electrode;
a liquid crystal layer;
a first dielectric layer formed between the pixel electrode and the liquid crystal layer having a first index of refraction and a first optical thickness; and
a second dielectric layer formed between the first dielectric layer and the liquid crystal layer having a second index of refraction and a second optical thickness, wherein the second index of refraction is larger than the first index of refraction and the second optical thickness is larger than the first optical thickness.

2. The device of claim 1, comprising at least one additional dielectric layer formed between the second dielectric layer and the liquid crystal layer, wherein the at least one additional dielectric layer includes a third dielectric layer having a third index of refraction and the second optical thickness.

3. The device of claim 2, wherein the at least one additional dielectric layer includes a fourth dielectric layer formed between the third dielectric layer and the liquid crystal layer, the fourth dielectric layer having a fourth index of refraction larger than the third index of refraction and the second optical thickness.

4. The device of claim 1, wherein the first dielectric layer is selected from the group consisting of silicon oxide, barium fluoride, sodium fluoride, magnesium fluoride, aluminum fluoride, calcium fluoride, and strontium fluoride.

5. The device of claim 1, wherein the second dielectric layer is selected from the group consisting of silicon nitride, titanium oxide, tantalum oxide, cerium oxide, aluminum oxide, magnesium oxide, hafnium oxide, zirconium oxide, antimony oxide, and cerium fluoride.

6. The device of claim 2, wherein the third dielectric layer is selected from the group consisting of silicon oxide, barium fluoride, sodium fluoride, magnesium fluoride, aluminum fluoride, calcium fluoride, and strontium fluoride.

7. The device of claim 3, wherein the fourth dielectric layer is selected from the group consisting of silicon nitride, titanium oxide, tantalum oxide, cerium oxide, aluminum oxide, magnesium oxide, hafnium oxide, zirconium oxide, antimony oxide, and cerium fluoride.

8. The device of claim 1, wherein the first optical thickness is approximately 500 Å.

9. The device of claim 1, wherein the second optical thickness is approximately 750 Å.

10. A method of making a liquid crystal display device having a pixel electrode and a liquid crystal layer, comprising:
forming a first dielectric layer between the pixel electrode and the liquid crystal layer, the first dielectric layer having a first index of refraction and a first optical thickness; and
forming a second dielectric layer between the first dielectric layer and the liquid crystal layer, the second dielectric layer having a second index of refraction and a second optical thickness, wherein the second index of refraction is larger than the first index of refraction and the second optical thickness is larger than the first optical thickness.

11. The method of claim 10, further comprising at least one additional dielectric layer formed between the second dielectric layer and the liquid crystal layer, wherein the at least one additional dielectric layer includes a third dielectric layer having a third index of refraction and the second optical thickness.

12. The method of claim 11, wherein the at least one additional dielectric layer includes a fourth dielectric layer formed between the third dielectric layer and the liquid crystal layer, the fourth dielectric layer having a fourth index of refraction larger than the third index of refraction and the second optical thickness.

13. The method of claim 10, wherein the first dielectric layer is selected from the group consisting of silicon oxide, barium fluoride, sodium fluoride, magnesium fluoride, aluminum fluoride, calcium fluoride, and strontium fluoride.

14. The method of claim 10, wherein the second dielectric layer is selected from the group consisting of silicon nitride, titanium oxide, tantalum oxide, cerium oxide, aluminum oxide, magnesium oxide, hafnium oxide, zirconium oxide, antimony oxide, and cerium fluoride.

15. The method of claim 11, wherein the third dielectric layer is selected from the group consisting of silicon oxide, barium fluoride, sodium fluoride, magnesium fluoride, aluminum fluoride, calcium fluoride, and strontium fluoride.

16. The method of claim 12, wherein the fourth dielectric layer is selected from the group consisting of silicon nitride, titanium oxide, tantalum oxide, cerium oxide, aluminum oxide, magnesium oxide, hafnium oxide, zirconium oxide, antimony oxide, and cerium fluoride.

17. The method of claim 10, wherein the first optical thickness is approximately 500 Å.

18. The method of claim 10, wherein the second optical thickness is approximately 750 Å.
